(19) United States
(12) Patent Application Publication
(10) Pub. No.: US 2006/0001248 A1
(43) Pub. Date: Jan. 5, 2006

(54) Safety device used in case a vehicle rolls over

(76) Inventors: Gerard Queveau, Amik Farm (FR); Paul Queveau, Le Logis De La Chironniere (FR); Jean-Marc Guillez, Les Maisons Blanches (FR)

Correspondence Address: NAWROCKI, ROONEY & SIVERTSON;SUITE 401, BROADWAY PLACE EAST, 3433 BROADWAY STREET NORTHEAST, MINNEAPOLIS, MN, 554133009, US

(21) Appl. No.: 11/037,382

(22) Filed: Jan. 18, 2005

(30) Foreign Application Priority Data
Jul. 2, 2004 (FR) 0451412
Sep. 30, 2004 (FR) 0452207
Nov. 17, 2004 (FR) 0452652

(51) Int. Cl. B60R 21/13

(52) U.S. Cl. 280/756

(57) ABSTRACT

The invention relates to a safety device used in case a vehicle rolls over, said safety device comprising at least two curved bars (1, 1′), each curved bar having a first end and a second end, a first portion of the bar extending from the first end (5), and a second portion (7) of the bar extending from the second end (8), which second portion is substantially rectilinear, and the device further comprising two guide boxes (10), each box being provided with an elongate orifice (18) for receiving said second portion (7), said orifice (18) extending substantially transversely relative to said second portion (7), said box being designed to be secured to a structural portion of the vehicle. The invention also relates to a vehicle including such a device, and to a method for assembling said vehicle.

### BACKGROUND OF THE INVENTION

The present invention relates to a safety device used in case a vehicle rolls over, and in particular to such a safety device that comprises at least two curved bars, each curved bar having a first end and a second end, said bars being movable from a retracted position to a deployed position in case the vehicle rolls over.

In particular, such a device is designed for motor vehicles of the “convertible” type which are convertible into open-top vehicles, in which the roof, made up of a plurality of portions, can be either overlying the passenger compartment, when the roof is “up”, or else stowed away in the luggage compartment when the roof is “down” in the open-top configuration.

In such vehicles, it is essential to have a luggage compartment whose volume is as large as possible, in particular for stowing away the roof elements.

A safety device is already known, in particular from Document FR-0 451 302, whose various component parts are arranged such that the device is compact and is disposed in the top portion of the luggage compartment, thereby making it possible to make considerable stowage length available inside said compartment.

### SUMMARY OF THE INVENTION

An object of the invention is to improve a device of that type by proposing a safety device in which the geometrical shape of the bars is organized to optimize the stowage volume inside the luggage compartment.

To this end, and according a first aspect, the invention provides a safety device used in case a vehicle rolls over, said safety device comprising at least two curved bars, each curved bar having a first end and a second end, a first portion of the bar extending from the first end, and a second portion of the bar extending from the second end, said bars being movable from a retracted position to a deployed position in case the vehicle rolls over, the first ends of said bars being hinged to a support, in which safety device the second portion of each bar is substantially rectilinear, said device further comprising two guide boxes, each box being provided with an elongate orifice for receiving said second portion, said orifice extending substantially transversely relative to said second portion, said box being designed to be secured to a structural portion of the vehicle.

Such a device offers the advantage of making it possible to procure additional available space, which can advantageously be used for stowing retractable roof elements, or as additional stowage space in the rear trunk of the vehicle. It also makes it possible to simplify manufacturing by avoiding superfluous curving, and thus to reduce the cost of the device.

In one embodiment, the device further comprises:

a pre-stressed system for deploying each bar;

a trigger system that is activated in case the vehicle rolls over;

at least one locking member that maintains the pre-stress and that is released by means of the trigger system, thereby releasing each bar from its retracted position; and

at least two anti-reverse locks systems, each of which is disposed between the second end of each bar and a structural portion of the vehicle in order to prevent the bar from retracting when said bar is in the deployed position.

Each anti-reverse locks system may be a ratchet system, and in particular, each ratchet system is disposed inside the corresponding bar, in the vicinity of the second end of said bar, each ratchet system being arranged to co-operate with elements of complementary shape integral with or secured to a structural portion of the vehicle.

In one embodiment, the first end of each bar is hinged to a common central plate so that each of said two bars extends on a respective side of said plate, from a common face of said plate, and substantially symmetrically about a plane, a control device for locking and releasing each bar being provided on the same face of said plate, said hinging of each bar being achieved by means of a bearing comprising a stationary portion secured to the plate, and a moving portion secured to the first end of the bar, the plate being designed to be fixed to a structural element of the vehicle.

The stress, locking, and control members are thus grouped together very compactly on a common assembly plate. On the same one of its faces, the plate also supports the bearings for hinging the roll-bars. Therefore, instead of being disposed between the seat back and the luggage compartment, the locking, control, and pre-stress devices can be disposed in the top portion of said luggage compartment whose length is thus increased over most of its height.

In particular, the moving portion of the bearing is provided with a shape element which co-operates with the locking member of the locking system such as:

firstly to hold the bars stationary in their retracted and pre-stressed position by means of the locking member engaging with the shape element; and

secondly to release the curved bars by means of the locking member disengaging from the shape element.

Also in a particular embodiment, the pre-stressed system is disposed inside the stationary portion of the bearing and in the immediate vicinity of the moving portion of the bearing.

Also in a particular embodiment, the control devices for locking and releasing each bar are actuated by a common actuator.

In a second aspect, the invention provides a motor vehicle including a structural element and at least one such safety device, said device further comprising two guide boxes, each box being situated on a respective one of the sides of the vehicle and being secured to a portion of said structural element.

In one embodiment, the two guide boxes are interconnected via a link element that also supports the plate.

In particular, the assembly comprising the safety device and the link element is fixed to the structural element.

More particularly, said vehicle may include one or more roof elements that are retractable into a stowage position behind the seats, at least one of the roof elements being received in part under said structural element when in the retracted position.

In a third aspect, the invention provides a method for assembling such a vehicle, which method includes a first step for assembling an assembly comprising the safety device and the link element, and then a second step for mounting said assembly onto said structural element.

### BRIEF DESCRIPTION OF THE DRAWINGS

A particular embodiment of the invention is described below by way of non-limiting example and with reference to the accompanying diagrammatic drawings, in which:

FIG. 1 is a rear perspective view of a safety device for a motor vehicle, said device comprising two roll-bars, the device being incorporated into the passenger compartment of a motor vehicle;

FIGS. 2a and 2b are elevation views of one side of the device of FIG. 1, the roll-bar being shown respectively in the retracted position (FIG. 2a) and in the deployed position (FIG. 2b);

FIG. 3 is an exploded view of the various elements forming one side of the safety device of FIG. 1;

FIG. 4 is an enlarged section view of the guide box and of the ratchet system on line A-A of FIG. 2b;

FIG. 5 is a section view on line B-B of FIG. 4;

FIG. 6 is a section view from above on line VI-VI of FIG. 7, showing the roll-bar control assembly;

FIG. 7 is a section view taken along line VII-VII of FIG. 6;

FIG. 8 is section view taken along line VIII-VIII of FIG. 6;

FIG. 9 is a section view taken along line IX-IX of FIG. 6; and

FIGS. 10a and 10b are perspective views respectively from the rear and from the front of the safety device when said safety device is in the form of a pre-assembled module ready to be mounted into the passenger compartment of the vehicle.

### DETAILED DESCRIPTION OF THE INVENTION

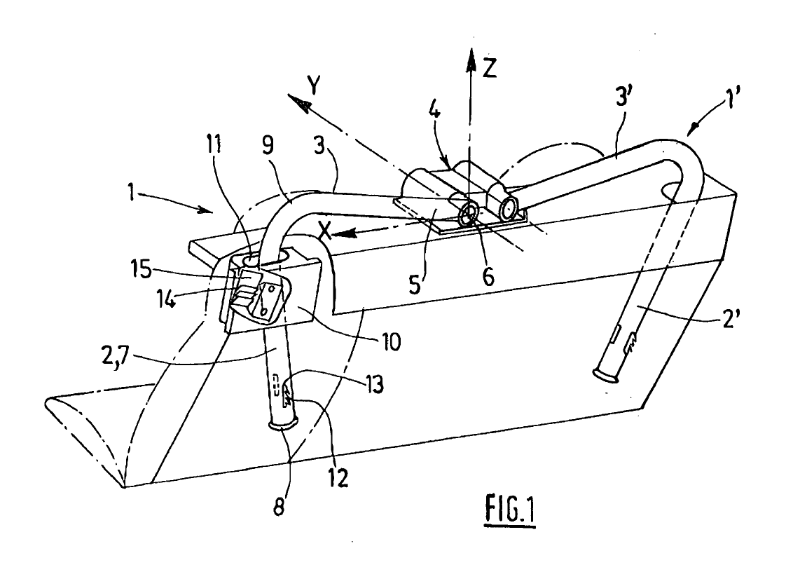

FIG. 1 shows two roll-bars 1 and 1′, each of which is constituted by a curved bar or tube forming two branches 2 & 3, 2′ & 3′.

The roll-bars 1 and 1′ are hinged symmetrically along two opposite edges of one face of a plate 4. Since the two roll-bars are symmetrical, only the roll-bar 1 and what is related to it is described below.

The branch 3 of the roll-bar 1 has its free end or “first” end hinged at 5 to the plate 4 so as to pivot in its plane relative to said plate.

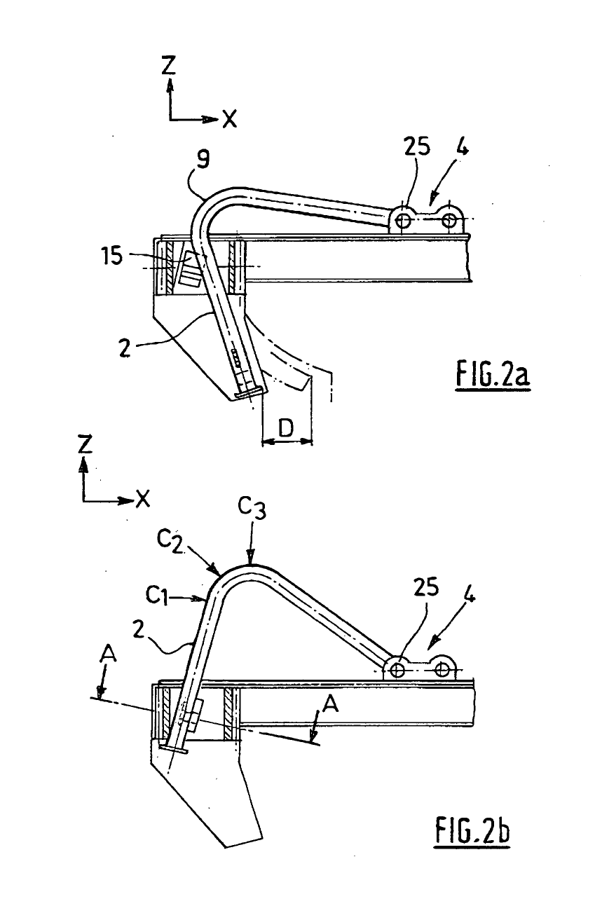

The bar portion 7 situated between the second end 8 of the bar 2 and the curved portion 9 is substantially rectilinear. FIG. 2a makes it possible to compare volume occupied by the bar when the portion starting from the second end is rectilinear, with the volume occupied by a bar in which that portion is curved, shown in dot-dash lines. Clearly, the curvature of the bar implies its protrusion into the vehicle, thereby causing space to be lost, represented by the distance D.

In addition, the guide box 10 for guiding the bar is secured to a structural portion of the vehicle, and it is provided with an orifice 11 of elongate shape for receiving the rectilinear portion 7 of the bar 2, the orifice 11 extending substantially transversely relative to the rectilinear bar portion, along direction X.

With reference to FIGS. 1 to 5, a description follows of the ratchet system that contributes to forming the anti-reverse lock system. This system is disposed inside the bar 2, in the vicinity of its second end 8.

The ratchet system comprises teeth 12 formed on the ratchets 13, which teeth co-operate with notches 14 between teeth that are formed on pads 15. Two substantially rectangular pads 15 are provided on either side of the bar 2, so that the teeth of each pad 15 face the periphery of the bar 2.

The pads 15 extend in two parallel planes that are substantially perpendicular to the axis Y along which the vehicle advances. The pads 15 are fixed inside the guide box 10.

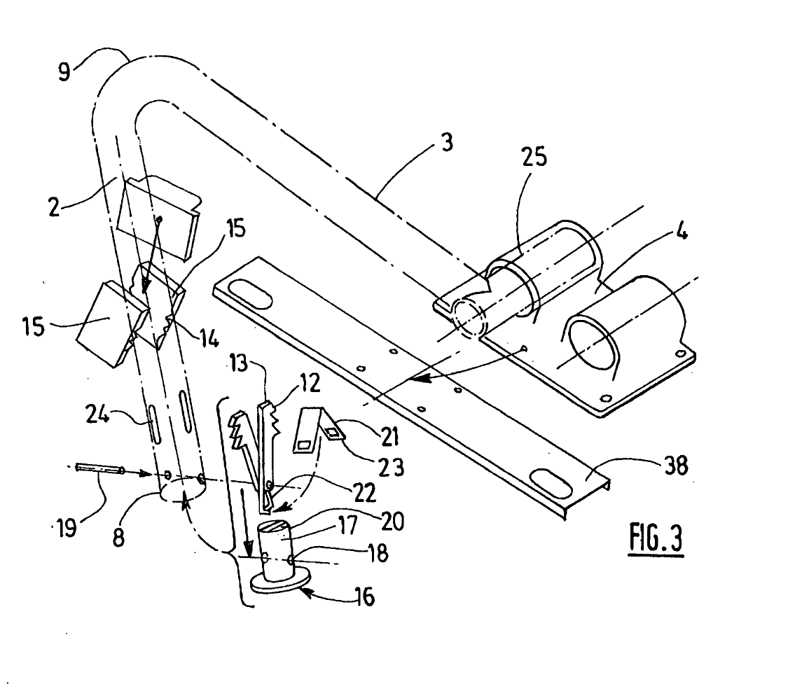

The ratchet system (see FIG. 3) includes a support 16 having a cylindrical portion 17 which is designed to be inserted into the second end 8 of the bar 2. The cylindrical portion 17 is provided with two orifices 18 receiving a pin 19 that serves as a hinge for the two ratchets 13. An inside portion of the cylindrical portion 17 is hollow so as to form two parallel flat parts 20 serving as abutments for the outside faces of the ratchets 13. Thus, the two ratchets are inserted between the two flat parts 20, thereby guaranteeing that the ratchets 13 are guided and held laterally in a satisfactory manner.

The ratchet system also includes a V-shaped blade spring 21. At its end opposite from its teeth 12, each ratchet 13 has an end 22 formed of an L-shaped finger. The short branch of the L-shape is inserted into a slot 23 provided in the end of each of the branches of the blade spring 21. In this way, in operation, the two ratchets 13 are pushed towards the outside of the bar 2 under the action of the blade spring 21. The teeth 12 of the ratchets 13 pass through two oblong-shaped holes 24 provided in the vicinity of the second end 8 of the bar 2, so that the teeth 12 project beyond the periphery of the bar 2.

As shown, the hinge pin 19 further makes it possible to fix the ratchet system to the end of the bar 2. In a variant, it is possible to make provision for the cylindrical portion 17 of the support 16 to be forced fitted into the bar 2, the entire ratchet system having been pre-assembled.

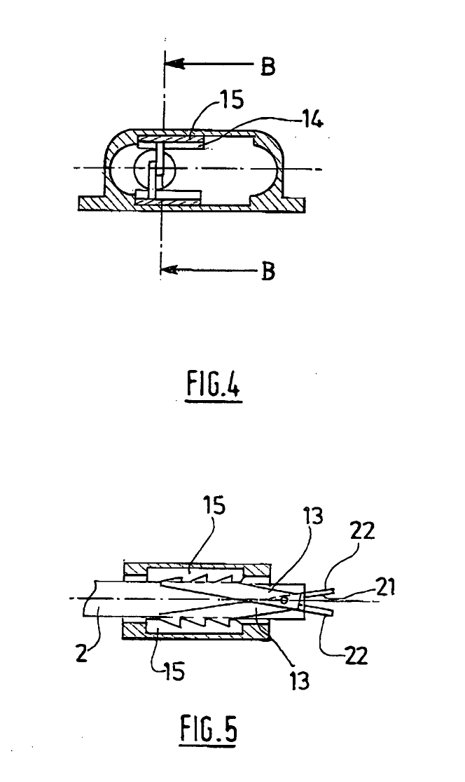

FIGS. 4 and 5 show the three teeth 12 of each ratchet 13 engaged in the three notches 14 of complementary shape formed in the pads 15, the bar 2 being, as shown in FIG. 2b, in the deployed position. It should be noted that, when operation of the device is tested, the ratchets 13 can be unlocked merely by manually pushing the fingers 22 on the two ratchets 13 towards each other in order to disengage the ratchets 13 from the pads 15, thereby enabling the bar 2 to be moved into its retracted position (FIG. 2a).

In addition, provision is made for the width of the pads 15 to be greater than the thickness of the teeth 12 on the ratchets 13 so that the ratchets 13 can make use of the entire width of the pads 15 in order to lock onto the teeth on the pads 15. Such an arrangement makes it possible to absorb a certain amount of inaccuracy, resulting from manufacturing and assembly tolerances, in the positions of the pads 15 relative to the ratchets 13. Therefore, the rectilinear shape of the portion 7 of bar 2 and the ratchet system can move freely between the pads 15. It is not therefore necessary to provide operating tolerance along direction X.

In addition, the fact that the ratchets 13 are hinged to the bar and can move along direction Y makes it possible to absorb certain positioning errors of the bar relative to the pads 15.

These two characteristics make it possible to accept manufacturing and assembly tolerances that are quite broad, thereby contributing to simplifying the device. In addition, said characteristics make it possible to remove the risks of the bar sticking or jamming as it is being deployed, because the bar does not encounter any obstacles along direction X, and can move freely along direction Y by means the ratchets 13 tilting.

In addition, the pads 15 are disposed on either side of the bar 2 so that their respective teeth, which are substantially rectilinear in shape, extend perpendicularly to the axis of the rectilinear portion 7 of the bar 2 when said bar is in the deployed position (FIG. 2b). Thus, in case the vehicle rolls over, the component of the forces acting along the axis of the rectilinear portion 7 of the bar 2 acts, via the teeth 12 on the ratchets 13, on the faces of the teeth on the pads 15 that are perpendicular to it.

The three arrows referenced C1, C2, C3 on FIG. 2b show how the force acting on the bar changes during the rollover of the vehicle, when said vehicle pivots about the axis Y counterclockwise. The arrow C1 represents the force acting on the bar when the vehicle is still on its side, the arrow C2 represents the force when the vehicle is in an intermediate position, and the arrow C3 represents the force once the vehicle has pivoted through 180 degrees. The device of the invention thus makes it possible to absorb optimally the forces acting on the bar while the vehicle is rolling over, by distributing them both over the bearing 25 of the plate 4 and over the ratchet system.

As the vehicle rolls over, the force acting on the bar is essentially absorbed by the bearing (arrow C1), then it is distributed between the bearing and the ratchet system (arrow C2), and finally it is absorbed essentially by the ratchet system (arrow C3). In this way, the components of the forces acting on the first and the second portions of bar act essentially in compression, thereby making it possible to optimize the crush resistance of the bar relative to said forces, as the vehicle rolls over. The rectilinear shape of the second bar portion makes it possible to avoid buckling stresses that inevitably occur in curved bars. This provision makes it possible to improve the crush resistance of the device.

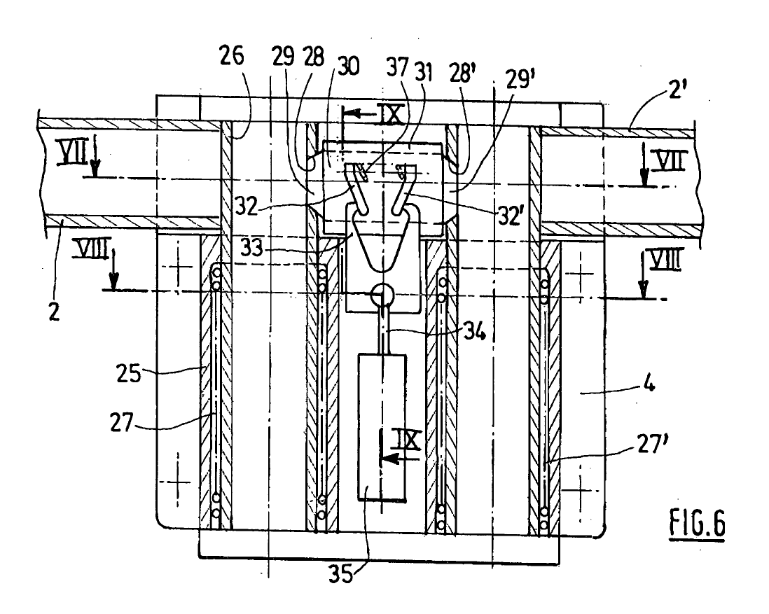

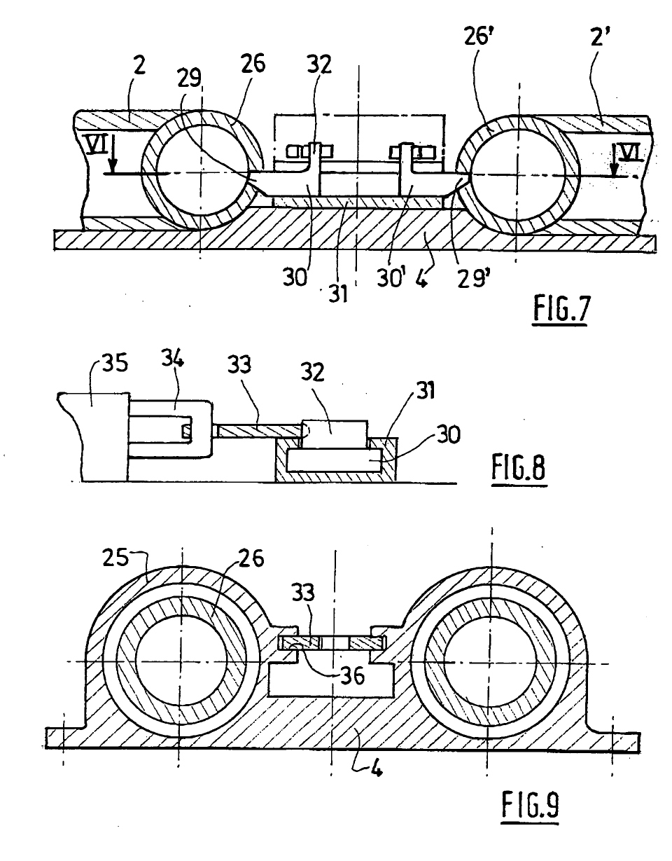

Reference is made to FIGS. 6 to 9 which show the control members for controlling the roll-bars.

The free end is fixed to a tube 26 engaged in the bearing-forming tubular portion 25 of the plate 4. A pre-stress spring 27 is disposed between the tube 26 and the tubular portion 25, one of its ends being fixed to the tube 26 and its other end being fixed to the tubular portion 25. The spring is pre-stressed when the roll-bar is in its retracted position.

The end of the tube 26 that extends beyond the tubular portion 25 is provided with a notch 28, into which a locking finger 29 can engage in order hold the roll-bar in the retracted position.

The locking finger 29 belongs to a control part 30 that is engaged in a guide part 31 which is secured to the plate 4. A control cam 32 extends from the part 30 substantially perpendicularly to the plate 4.

The control cam 32 is organized to co-operate with a locking control fork 33 mounted at the free end of a U-shaped rod 34 of a control actuator 35. The locking fork 33 is guided by grooves 36 formed in the outside walls of the tubular portions 25.

Finally, a return spring 37 urges the locking parts 30, 30′ back against the action of the locking fork 33.

When the roll-bars are to be deployed, the actuator 35 pushes the locking fork 33 so that the cams 32, 32′ cause the parts 30, 30′ to slide in the guide part 31. Therefore, the locking fingers 29, 29′ disengage from the notch 28 and the springs 27, 27′ cause the roll-bars to pivot and thus to be deployed.

The above-described control assembly offers the advantage of being very compact. Locking is achieved directly between the tube 26 and the bearing-forming tubular portion 25. In addition, the pre-stress spring 27 is disposed in the bearing.

In addition, the plate 4 supports both of the bearings so that it is possible to use a single, common actuator 35, offering the advantage of reducing the cost of the assembly. The plate 4 incorporates, inter alia, the functions of pre-stressing, locking, and triggering.

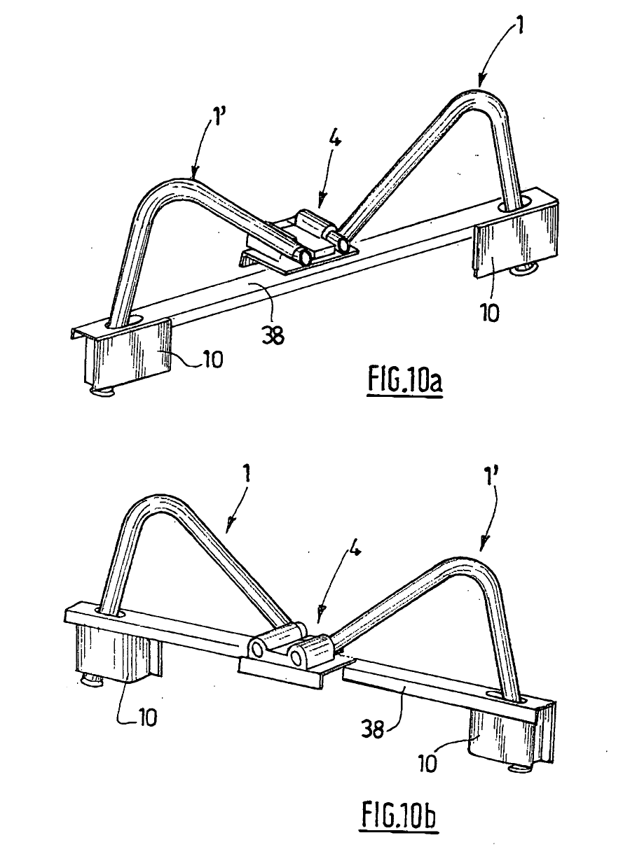

FIGS. 10a and 10b show a safety device of the invention including two guide boxes 10, each box being designed to be situated on one of the sides of the vehicle, by being secured to a portion of the structural element of the vehicle. The two guide boxes are interconnected via a transverse and substantially horizontal link element 38 which also supports the plate 4. The assembly comprising the safety device and the link element can advantageously be pre-assembled so as to form a module that is easy to mount on the structural element in the passenger compartment of the vehicle.

1. A safety device used in case a vehicle rolls over, said safety device comprising at least two curved bars, each curved bar having a first end and a second end, a first portion of the bar extending from the first end, and a second portion of the bar extending from the second end, said bars being movable from a retracted position to a deployed position in case the vehicle rolls over, the first ends of said bars being hinged to a support, said safety device being characterized in that the second portion of each bar is substantially rectilinear, in that said device further comprises two guide boxes, each box being provided with an elongate orifice for receiving said second portion, said orifice extending substantially transversely relative to said second portion, said box being designed to be secured to a structural portion of the vehicle.

2. A safety device according to claim 1, characterized in that it comprises at least two anti-reverse lock systems, each of which is disposed between the second end of each bar and a structural portion of the vehicle in order to prevent the bar from retracting when said bar is in the deployed position.

3. A device according to claim 1, characterized in that it further comprises:
a pre-stressed system for deploying each bar;
a trigger system that is activated in case the vehicle rolls over;
at least one locking member that maintains the pre-stress and that is released by means of the trigger system, thereby releasing each bar from its retracted position; and
at least two anti-reverse lock systems, each of which is disposed between the second end of each bar and a structural portion of the vehicle in order to prevent the bar from retracting when said bar is in the deployed position.

4. A device according to claim 2, characterized in that each anti-reverse lock system is a ratchet system.

5. A device according to claim 4, characterized in that each ratchet system is disposed inside the corresponding bar, in the vicinity of the second end of said bar, each ratchet system being arranged to co-operate with elements of complementary shape integral with or secured to a structural portion of the vehicle.

6. A device according to claim 5, characterized in that each ratchet system comprises two ratchets hinged relative to each other about a pin, each ratchet having one end provided with teeth and one end arranged to be inserted into a blade spring, said spring assisting movement of the two ratchets.

7. A device according to claim 5, characterized in that said elements of complementary shape are formed on pads fixed inside the guide box.

8. A device according to claim 7, characterized in that said elements of complementary shape are constituted by notches arranged to co-operate with the teeth formed on the ratchets.

9. A device according to claim 1, characterized in that the first end of each bar is hinged to a common central plate so that each of said two bars extends on a respective side of said plate, from a common face of said plate, and substantially symmetrically about a plane, a control device for locking and releasing each bar being provided on the same face of said plate, said hinging of each bar being achieved by means of a bearing comprising a stationary portion secured to the plate, and a moving part secured to the first end of the bar, the plate being designed to be fixed to a structural element of the vehicle.

10. A device according to claim 9, characterized in that the moving portion of the bearing is provided with a shape element which co-operates with the locking member of the locking system, such as:
firstly to hold the bars stationary in their retracted and pre-stressed position by means of the locking member engaging with the shape element; and
secondly to release the curved bars by means of the locking member disengaging from the shape element.

11. A motor vehicle including a structural element and at least one safety device according to claim 1, characterized in that said device further comprises two guide boxes, each box being situated on a respective one of the sides of the vehicle and being secured to a portion of said structural element.

12. A motor vehicle according to claim 11, characterized in that the two guide boxes are interconnected via a link element that also supports the plate.

13. A motor vehicle according to claim 12, characterized in that the assembly comprising the safety device and the link element is fixed to the structural element.

14. A motor vehicle according to claim 11, characterized in that the common central plate for the two bars is secured to said structural element of the vehicle.

15. A vehicle according to claim 11, characterized in that it has a roof made up of one or more elements that are retractable into a stowage position behind the seats, and in that one or more of the roof elements are received in part under said structural element when in the retracted position.

16. A method of assembling a vehicle according to claim 11, said method being characterized in that it includes a first step for assembling an assembly comprising the safety device and the link element, and then a second step for mounting said assembly onto said structural element.
